(19) United States
(12) Patent Application Publication
(10) Pub. No.: US 2006/0041695 A1
(43) Pub. Date: Feb. 23, 2006

(54) Display apparatus whose signal processing unit is separated

(75) Inventor: Weon-Mok Lee, Gyeongsangbuk-do (KR)

Correspondence Address: APEX JURIS, PLLC, 13194 EDGEWATER LANE NORTHEAST, SEATTLE, WA, 98125, US

(73) Assignee: D. BOSS CO. LTD, GYEONGSAGSANGBUK-DO (KR)

(21) Appl. No.: 10/522,065

(22) PCT Filed: Jul. 22, 2002
(86) PCT No.: PCT/KR02/01367

§ 371 Date: Jul. 15, 2005

(51) Int. Cl. G06F 3/00

(52) U.S. Cl. 710/64; 710/8

(57) ABSTRACT

The present invention relates to a flap type display apparatus, and particularly to a display apparatus in which an image display unit such as a LCD panel, and a diving circuit, i.e., a signal processing unit for controlling the image display unit, are separated each other. A display apparatus whose signal processing unit is separated according to the present invention is comprised of: an image display unit for displaying an image; a signal processing unit installed separately independent of the image display unit, for converting external signal so that the image display unit operates; and a signal connecting unit for connecting the image display unit and the signal processing unit.

### TECHNICAL FIELD

The present invention relates to a apparatus such as a PDP, an LCD, a television set and a monitor, and more particularly, to a apparatus in which an image display unit such as an LCD panel, and a signal processing unit, i.e., a driving circuit for controlling the image display unit are separated from each other.

### BACKGROUND ART

Nowadays, liquid crystal displays (LCDs) are widely used in a desktop computer or a wall hanging television because they are thinner and lighter and consume much less power compared with a CRT.

Since such a flat panel LCD is easy to install, it is mounted on a wall for the maximization of use of space, or attached to a ceiling portion of a train and a bus.

FIG. 1 illustrates a conventional flat panel LCD.

Referring to FIG. 1, the conventional LCD includes an image display unit 11 such as LCD panel for displaying an image according to an inputted signal, a driving circuit 13 for converting the signal inputted from the outside so that the image display unit 11 can receive it, a driving signal connector 12 for connecting the image display unit 11 with the driving circuit 13 for signal transmission between the Image display unit 11 and the driving circuit 13, an external signal receiver 14 which is formed at the driving circuit 13 and receives signals such as a television antenna signal, a VCR signal, a DVD signal, a PC signal and the like which a user intends to display, an inverter 15 for generating a high voltage required for the image display unit 11, and an inverter converter 16 for supplying the image display unit 11 with the voltage generated by the inverter 15.

Next, the conventional flat LCD constructed as above will be described. The signal inputted to the external signal receiver 14 is converted by the driving circuit 13 into the signal which the image display unit 11 can receive. The converted signal is inputted to the image display unit 11 through the driving signal connector 12. The Inverter 15 generates the high voltage to drive the image display unit 11 and transfers the high voltage to the image display unit 11 through the inverter connector 16. The image display unit 11 receives the inputted signal and displays the signal desired by the user.

The conventional flat panel LCD includes the image display unit 11 such as an LCD panel and the driving circuit 13 for converting an external signal so as to drive the image display unit 11, and the Image display unit 11 is integrated with the driving circuit 13 in the conventional flat panel LCD.

In other words, the driving circuit 13 is installed at the rear portion or the side portion of the image display unit 11, and the driving circuit 13 and the image display unit 11 transfer signals to each other through the driving signal connector 12.

FIG. 2 illustrates a conventional flat panel LCD with a set top box.

In general, the set top box is a device for receiving satellite broadcast signals, digital broadcast signals and the like and converting them into the signals that a general television set can receive. The set top box 28 is usually installed separated from a display unit.

Referring to FIG. 2, the flat panel LCD with the set top box includes an image display unit 11 such as LCD panel for displaying an image according to an inputted signal, a driving circuit 13 for converting the signal inputted from the outside so that the image display unit 11 can receive it, a driving signal connector 12 for connecting the image display unit 11 with the driving circuit 13 so as to transfer the signal from and to them, a set top box signal receiver 19 connected to the driving circuit 13 for receiving the signal that a user intends to display from the set top box, an inverter 15 for generating a high voltage required for the image display unit 11, an inverter converter 16 for supplying the image display unit 11 with the voltage generated by the inverter 15, a connection signal cable 9 for connecting to the set top box signal receiver 19, a set top box signal output unit 20 connected to the set top box signal receiver 19 throughthe connection signal cable 9, a set top box signal processor 17 which is connected to the set top box signal output unit 20 and processes the signal received from the outside, an external signal receiver 14 for receiving signals from the outside, and an external signal processor case 18.

The external signal processor case 18 can be installed in the set top box but the set top box signal processor 17 can be installed in the set top box without the external signal processor case 18.

Based on the configuration described above, the conventional flat LCD with a set top box will be described. When a signal such as a television antenna signal, a VCR signal, a PC signal and, the like is inputted to the external signal receiver 14, the external signal processor case 18 or the set top box signal processor 17 installed in the set top box converts the external signal into the signal which the driving circuit 13 can receive. The converted signal is inputted to the driving circuit 13 through the set top box signal output unit 20, the connection signal cable 9 and the set top box signal receiver 19. The driving circuit 13 converts the received signal so as to drive the image display unit 11 through the driving signal connector 12.

The inverter 15 generates the high voltage to drive the image display unit 11 and transfers the high voltage to the image display unit 11 through the inverter connector 16. The image display unit 11 receives the inputted signal and displays the signal desired by the user.

The conventional flat panel LCD is thinner and lighter than the conventional CRT but It has a limitation in satisfying the desire of the users who want a thinner and lighter apparatus since the driving circuit 13 is installed at the rear portion or the side portion of the image display unit 11.

The conventional flat panel LCD gets heavier as it gets larger due to the users' desire. Also, it is requested that a stand for the flat panel LCD be manufactured more strongly to endure the weight of the flat panel LCD since the conventional flat panel LCD is mounted on a ceiling or a wall, which increases the weight of the stand. Accordingly, the installation place to place the stand is limited in choice.

Additionally, since the conventional flat panel LCD as used should receive all the external signals at its installation place, the installation place of the conventional flat panel LCD is limited. Too many external signals cause the signal lines for the external signals to be complicated, which causes inconvenience in its use and defiles the appearance of the installation place.

### DISCLOSURE OF THE INVENTION

Accordingly, the present invention is directed to a apparatus whose signal processing unit is separated that substantially obviate one or more of the problems due to limitations and disadvantages of the related art.

An object of the present invention is to install an image processing unit including a driving circuit for driving an image display unit to be separated from the image display unit so that a apparatus can be manufactured thinner and lighter to meet users' desire.

Another object of the present invention is to reduce the thickness and the weight of the apparatus and remove the limitation in the installation place.

Another object of the present invention is to overcome inconvenience due to signal lines for external signals.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a display apparatus whose signal processing unit is separated according to the present invention includes an image display unit for displaying an image; a signal processing unit separated from the image display unit, for converting an external signal into a signal which drive the image display unit; and a signal connecting unit for connecting the image display unit with the signal processing unit.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are Incorporated in and constitute a part of this specification, illustrate embodiments of the invention and together with the description serve to explain the principles of the invention.

In the drawings:

FIG. 1 illustrates a conventional flat panel LCD;

FIG. 2 illustrates a conventional flat panel LCD connected with a set top box;

FIG. 3 illustrates a apparatus whose signal processing unit is separated according to the present invention;

FIG. 4 illustrates that a signal processing unit is installed in a set top box in a apparatus whose signal processing unit is separated according to the present invention; and

FIG. 5 illustrates that a signal processing unit is installed at a computer main board in a apparatus whose signal processing unit is separated according to the present invention.

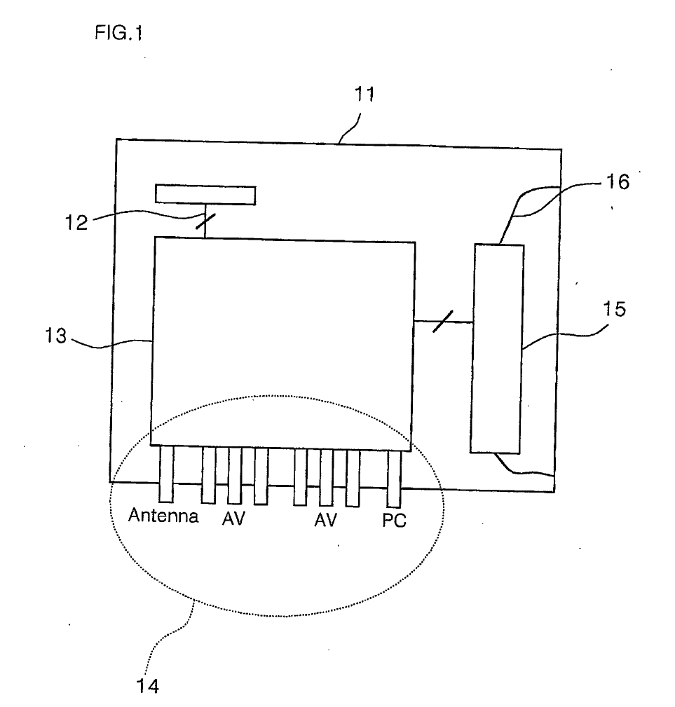

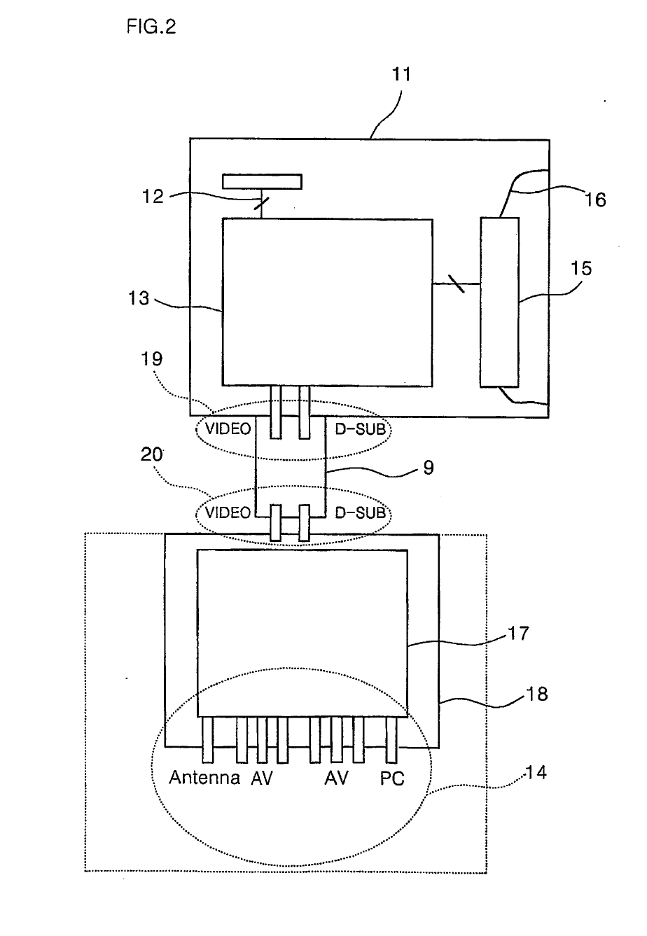

### BEST MODE FOR CARRYING OUT THE INVENTION

Reference will now be made in detail to the preferred embodiments of the present invention, examples of which are illustrated in the accompanying drawings.

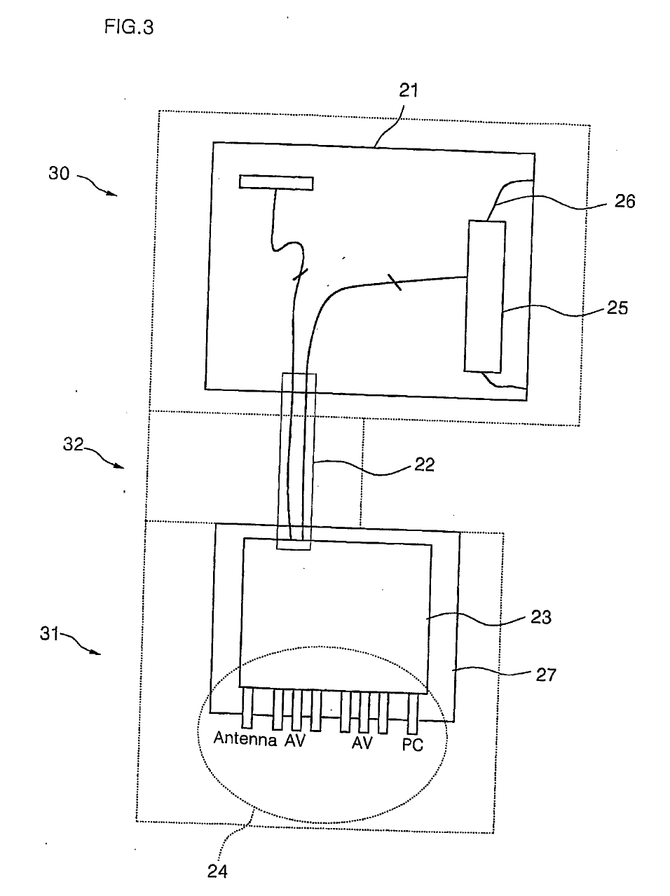

FIG. 3 illustrates a apparatus whose signal processing unit is separated according to the present invention.

Referring to FIG. 3, a apparatus whose signal processing unit is separated according to the present invention includes an image display unit for displaying an image, a signal processing unit 31 which is separated from the image display unit 30 and converts an external signal into a signal which drive the image display unit 30, and a signal connecting unit 32 for connecting the image display unit 30 with the signal processing unit 31.

The image display unit 30 includes an image display part 21 for displaying the image according to the inputted signal, an inverter 25 for generating a high voltage required for the image display part 21, and an inverter connector 26 for supplying the image display unit 30 with the high voltage generated by the inverter 25.

The signal processing unit 31 includes a driving circuit 23 for converting the external signal into the signal so that the image display part 21 can receive the signal, and an external signal receiver 24 which is formed at the driving circuit 23 and receives signals which a user intends to display.

More preferably, the signal processing unit 31 further includes a signal processing case 27 in which the driving circuit 23 and the external signal receiver 24 are installed.

The signal connecting unit 32 consists of a driving signal connector 22.

Detail description is as follows. The image display part 21 is a flat panel apparatus and exemplified by LCD panel, PDP, FED and the like.

The inverter 25 is installed at one side of the image display part 21 and supplies the image display part 21 with the high voltage through the inverter connector 26.

The external signal receiver 24 is connected to one side of the driving circuit 23 and provided with a terminal through which a television antenna signal, a VCR signal, a PC signal and the like are applied.

The driving signal connector 22 connects the image display unit 30 with the signal processing unit 31 and transfers the signal converted by the signal processing unit 31 to the image display unit 30. The length of the driving signal connector 22 can be extended freely. The image display unit 30 is connected to the signal processing unit 31 through one connector.

Based on the above-mentioned configuration, the apparatus whose signal processing unit is separated will be described. When a signal that a user intends to display is applied to the external signal receiver 24 of the signal processing unit 31 separated from the image display unit 30, the driving circuit 23 converts the external signal into the signal that drives the image display part 21.

The converted external signal is transferred to the image display part 21 and the inverter 25 of the image display unit 30 separated from the signal processing unit 31 through the driving signal connector 22.

The signal transfer through the driving signal connector 22 can be achieved in a TMDS method or an LVDS method. The inverter 25 generates the high voltage and the high voltage is transferred to the image display part 21 through the inverter converter 26. According to this signal, the image display part 21 displays the image which the user wants.

Meanwhile, the characteristic of the apparatus whose signal processing unit 31 is separated will be described again. The signal processing unit 31 converts an external signal into a signal which controls the image display unit 30 for displaying an image, and is separated from the image display unit 30. The signal connecting unit 32 connects the image display unit 30 with the signal processing unit 31.

in other words, the image display unit 30 is separated from the signal processing unit 31 and each of them is installed in a separate space.

Now, the embodiments in which the signal processing unit 31 is installed at different places will be described.

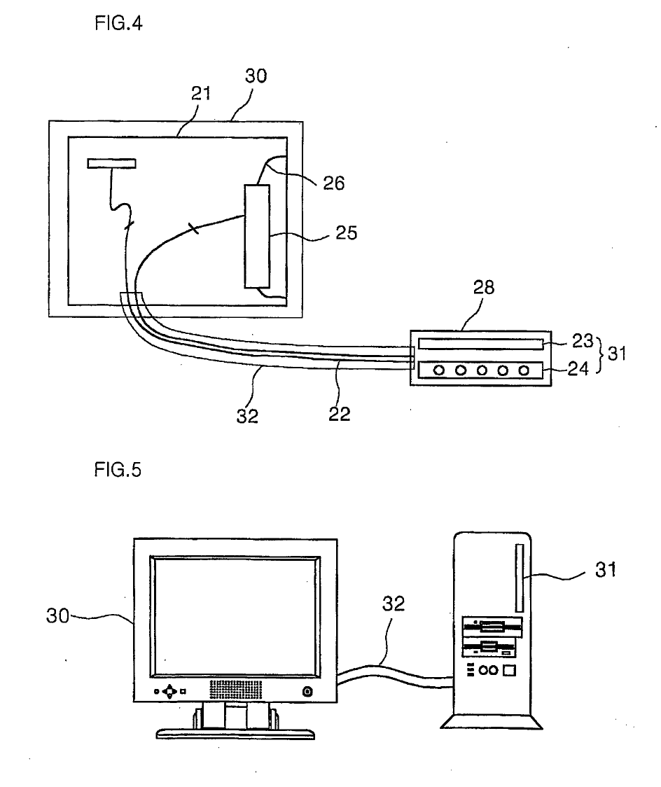

FIG. 4 illustrates that a signal processing unit 31 is installed in a set top box in a apparatus whose signal processing unit is separated according to the present invention.

Referring to FIG. 4, a apparatus whose signal processing unit is separated according to the present invention includes an image display unit 30 for displaying an image; a signal processing unit 31 installed at a set top box 28 separated from the image display unit 30, for converting an external signal into a signal for driving the image display unit 30; and a signal connecting unit 32 for connecting the image display unit 30 with the signal processing unit 31.

Accordingly, contrast to the conventional apparatus, the signal processing unit 31 is installed separated from the image display part 21.

The image display unit 30 includes an image display part 21 for displaying the image according to the inputted signal, an inverter 25 for generating a high voltage required for the image display part 21, and an inverter connector 26 for supplying the image display unit 21 with the high voltage generated by the inverter 25.

The signal processing unit 31 includes a driving circuit 23 for converting the signal inputted from the outside into the signal so that the image display part 21 can receive the signal, and an external signal receiver 24 which is formed at the driving circuit 23 and receives signals which a user intends to display.

The signal connecting unit 32 consists of a driving signal connector 22.

Detail description is as follows. The image display part 21 is a flat panel apparatus and exemplified by electric field emission display elements such as LCD panel, PDP, FED and the like.

The inverter 25 is installed at one side of the image display part 21 and supplies the image display part 21 with the high voltage through the inverter connector 26.

The external signal receiver 24 is connected to one side of the driving circuit 23, installed at the outside of the set top box 28, and provided with a terminal through which a television antenna signal, a VCR signal, a PC signal and the like are applied.

The driving signal connector 22 connects the image display unit 30 with the signal processing unit 31 installed in the set top box 28, and transfers the signal converted by the signal processing unit 31 to the image display unit 30. The length of the driving signal connector 22 can be extended freely. The image display unit 30 is connected to the signal processing unit 31 through one connector.

In other words, the image display unit 30 which includes the image display part 21, the inverter 25 and the inverter connector 26 is placed at a wall or a stand and the signal processing unit 31 that includes the driving circuit 23 and the external signal receiver 24 is installed in the set top box 28.

Based on the above-mentioned configuration, the apparatus whose signal processing unit is separated will be described. When a signal that a user intends to display is applied to the external signal receiver 24 of the signal processing unit 31 that is installed in the set top box 28 and separated from the image display unit 30, the driving circuit 23 converts the external signal into the signal that drives the image display part 21.

The converted external signal is transferred to the image display part 21 and the inverter 25 of the image display unit 30 separated from the signal processing unit 31 through the driving signal connector 22.

The signal transfer from and to the image display unit 30 and the driving circuit 23 of the set top box 28 can be achieved through the driving signal connector 22 in a TMDS method or an LVDS method. The inverter 25 generates the high voltage and the high voltage is transferred to the image display part 21 through the inverter converter 26. According to this signal, the image display part 21 displays the image that the user wants.

FIG. 5 illustrates that a signal processing unit is installed at a computer main board in a apparatus whose signal processing unit is separated according to the present invention.

Referring to FIG. 5, a desktop computer includes the image display unit 30 such as a monitor and a body in which a main board on which a sound card, a video card and the like are installed is installed. In another embodiment of the present invention, the signal processing unit 31 is not installed in the computer monitor but installed on the main board of the computer body. The configuration of other components is as the embodiment illustrated in the FIG. 4.

In other words, when an external signal is applied to the signal processing unit 31 that is installed in the main board and separated from the image display unit 30, the external signal is transferred to the image processing unit 30 through the signal connecting unit 32 and the image that the user wants is displayed.

On the other hand, the present invention is not limited to the embodiments. It will be apparent to those skilled in the art that various modifications and variations in which the signal processing unit is installed separated from the image display unit, for example, the signal processing unit is placed on the stand for a desktop monitor can be made therein without departing from the spirit and scope of the invention.

### INDUSTRIAL APPLICABILITY

A apparatus whose signal processing unit is separated according to the present invention is thinner and lighter than the conventional flat panel LCD.

Since the apparatus whose signal processing unit is separated according to the present invention has the thinner thickness, it can be placed anywhere without any limitation.

Since the length of the driving signal connector of the present invention can be extended freely, users can change the installation locations of the image apparatus and the signal processing unit freely and it is convenient for the users to use.

Since the image display unit is connected to the signal processing unit through one connector, complicated connection lines such as external input signal lines are not seen apparently when an image apparatus is installed. It gives good appearance.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A display apparatus whose signal processing unit is separated, the display apparatus comprising:
an image display unit for displaying an image;
the signal processing unit installed independently separated from the image display unit, for converting an external signal into a signal for driving the image display unit; and
a signal connecting unit for connecting the image display unit with the signal processing unit.

2. The display apparatus of claim 1, wherein the image display unit comprises:
an image display part for displaying the image according to the inputted signal;
an inverter for generating a high voltage required for the image display part; and
an inverter connector for supplying the image display part with the high voltage generated in the inverter.

3. The display apparatus of claim 1, wherein the signal processing unit comprises:
a driving circuit for converting the external signal so that the image display unit can receive the signal; and
an external signal receiver formed at the driving circuit, for receiving signals which a user intends to display.

4. The display apparatus of claim 3, wherein the external signal receiver is a television antenna signal receiver.

5. The display apparatus of claim 3, wherein the external signal receiver is a VCR signal receiver.

6. The display apparatus of claim 3, wherein the external signal receiver is a PC signal receiver.

7. The display apparatus of claim 3, wherein the external signal receiver is a DVD signal receiver.

8. The display apparatus of claim 3, wherein the signal processing unit further comprises a signal processing case in which the driving circuit and the external signal receiver are installed.

9. The display apparatus of claim 1, wherein the signal connecting unit is a driving signal connector.

10. A display apparatus whose signal processing unit is separated, the display apparatus comprising:
an image display unit for displaying an image;
the signal processing unit installed at a set top box separated from the image display unit, for converting an external signal into a signal for driving the image display unit; and
a signal connecting unit for connecting the image display unit with the signal processing unit.

11. The display apparatus of claim 10, wherein the image display unit comprises:
an image display part for displaying the image according to the inputted signal;
an inverter for generating a high voltage required for the image display part; and
an inverter connector for supplying the image display part with the high voltage.

12. The display apparatus of claim 10, wherein the signal processing unit comprises:
a driving circuit for converting the external signal so that the image display unit can receive the signal; and
an external signal receiver formed at the driving circuit, for receiving signals which a user intends to display.

13. The apparatus of claim 10, wherein the signal connecting unit is a driving signal connector.

14. A display apparatus whose signal processing unit is separated, the display apparatus comprising:
an image display unit for displaying an image;
a signal processing unit installed at a main board separated from the image display unit, for converting an external signal into a signal for driving the image display unit; and
a signal connecting unit for connecting the image display unit with the signal processing unit.

15. The display apparatus of claim 14, wherein the image display unit comprises:
an image display part for displaying the image according to the inputted signal;
an inverter for generating a high voltage required for the image display part; and
an inverter connector for supplying the image display part with the high voltage.

16. The display apparatus of claim 14, wherein the signal processing unit comprises:
a driving circuit for converting the external signal so that the image display unit can receive the signal; and
an external signal receiver formed at the driving circuit, for receiving signals which a user intends to display.

17. The display apparatus of claim 14, wherein the signal connecting unit is a driving signal connector.

18. A display apparatus whose signal processing unit is separated, the display apparatus comprising:
an image display part for displaying the image according to the inputted signal;
an inverter for generating a high voltage required for the image display part;
an inverter connector for supplying the image display part with the high voltage;
a driving circuit separated from the image display part, for converting the external signal into the signal so that the image display part can receive the signal;
an external signal receiver formed at the driving circuit, for receiving signals which a user intends to display; and
a driving signal connector for connecting the driving circuit with the image display part and the inverter.

19. The display apparatus of claim 18, further comprising a signal processing case in which the driving circuit and the external signal receiver are installed.
